(19) United States
(12) Patent Application Publication
(10) Pub. No.: US 2014/0272025 A1
(43) Pub. Date: Sep. 18, 2014

(54) BEVERAGE BREWING APPARATUS WITH USER-VARIABLE, FLOW-CONTROLLED HEATING AND BY-PASS DISPENSING OF A LIQUID

(71) Applicant: BOYD COFFEE COMPANY, Portland, OR (US)

(72) Inventor: David Wheeler, Portland, OR (US)

(73) Assignee: Boyd Coffee Company, Portland, OR (US)

(21) Appl. No.: 13/842,279

(22) Filed: Mar. 15, 2013

(51) Int. Cl. A47J 31/46

(52) U.S. Cl. CPC A47J 31/46
USPC 426/231; 99/300; 99/285; 99/283

(57) ABSTRACT

A beverage brewing device includes a pump that delivers water at a controlled rate to a heater via a conduit, and subsequently to a dispensing outlet for brewing a beverage. The heater heats the water to a target temperature designated by a user via a control interface. A thermal sensor measures the temperature of the heated water, and logic circuitry of a controller determines the presence of a deviation relative to a user-designated temperature. If a difference is detected, the controller affects the pump, correspondingly affecting a flow rate of water through the heater, until a water temperature measurement attains the designated temperature. A display device displays water temperature, flow rate, or user-selectable operational settings. Additionally, a bypass conduit having a user-adjustable flow control device diverts a portion of the heated water past a flavoring medium and into a brewed beverage reservoir at a controlled, user-variable flow rate.

### FIELD OF THE INVENTION

The invention relates generally to the field of beverage preparation, and more particularly, the invention relates to a brewing apparatus for hot beverages.

### BACKGROUND OF THE INVENTION

Devices for brewing heated beverages such as coffee and tea have long included a relatively common design. A fluid reservoir, or boiler, heats a quantity of water to a preset target temperature. When the water attains the target temperature, it is dispensed over and through a particulate flavoring medium, such as ground coffee beans tea leaves, chicory root, cinnamon bark, etc. The heated water leaches flavoring compounds from the flavoring medium, then drains into a brewed beverage receptacle where heating may resume to maintain the brewed beverage at a constant temperature for an extended duration.

Several factors affect the flavor of a brewed beverage, such as the variety or blend of the flavoring medium, the coarseness (or ‘grind’) of a particulate flavoring medium, the amount of flavoring medium used, the flow rate of the water through the flavoring medium, and other factors. In particular, the temperature of the water as it passes through the flavoring medium is a key determinant of the resulting flavor of the brewed beverage. If the water is too hot, bitter alkaloids leach to an increased degree, and may predominate in the beverage flavor. If the water temperature is too low, it may leach an insufficient amount of flavoring compounds, resulting in a weak flavor.

The boiler method of heating water presents several deficiencies that limit a user's ability to produce a consistently flavored brewed beverage, or to precisely adjust a beverage flavor to the user's preference while holding all other flavor-affecting factors constant. For example, a thermal sensor used to determine the temperature of the water in the boiler typically measures the water temperature indirectly, or measures the temperature of the water in only one portion of the boiler. Inconsistencies of the water temperature throughout different portions of the boiler likewise adds variability to the brewing process and an inconsistent brewing result. Additionally, the water cools while draining from the reservoir, resulting in unpredictability regarding an actual temperature of water arriving at the flavoring medium.

In other brewing devices, unheated water drains from a reservoir, typically driven only by gravity, and is then exposed to a heating element. However, there is no direct monitoring of the water temperature, nor user-controlled provisions for adjusting flow rate or other factors to assure the water delivered for brewing consistently attains, and in particular maintains, a target temperature for brewing. Instead, cycling on and off the operating power to the heating element is the only user-operable thermal control during the brewing process, or the level of power delivered to the heating element itself may be modulated.

Therefore, with regard to heating water for brewing, present beverage brewing devices essentially operate under a blind ‘set and forget’ principle that is subject to considerable variation and uncertainty, and leading to inconsistency in the quality of the brewed beverage. The user is generally provided only with controls to turn the brewing device on or off, and may be provided with a timer for the same, but generally the user is unaware of the actual temperature of the water being used for brewing, and is provided with few or no temperature control options.

Additionally, water pumps used in association with existing beverage preparation devices frequently expressly require that a liquid at the inlet to the pump must be pressure-less. Such requirement precludes connecting a beverage preparation device to a convenient but typically pressurized water source, such as a household tap. For the same reason, static fluid pressure inherent in a larger reservoir used as a water source provided within or coupled with the device may additionally limit an amount of water that can be retained in the reservoir (e.g., a tank, etc.). Such limitations significantly limit the feasible implementation of a flow-thru heater arrangement in a beverage brewing device.

Additionally, the flavor and other characteristics of a brewed beverage can be affected by including a bypass flow path, which diverts a portion of the heated water away from the flavoring medium and instead routes it directly into a receptacle containing the brewed beverage. This heated bypass water dilutes the brewed beverage, and depending on the amount of bypass water added, can be used to ‘tune’ the flavor of the brewed beverage.

Existing brewing devices do not, however, include provisions enabling a user to adjust a flow rate of the bypass water to suit their preferences. Instead, they only provide for a single, constant flow rate, or a limited number of flow rate options that are preset when the brewing device is manufactured, providing no user-operable control or variation outside of the factory presets. Therefore, if a user wishes to adjust the amount of water in a brewed beverage, they typically must remove the flavoring medium from the brewing device, add more water to the boiler or source reservoir, and simply run water through the brewing device and directly into the brewed beverage. Alternatively, a user can obtain heated water from an extrinsic source, and simply pour it into a receptacle containing an already brewed beverage. Neither method is convenient, efficient, or precise, and neither provides a user with substantial control over the brewing performance of the beverage brewing device.

### BRIEF DESCRIPTION OF THE DRAWINGS

FIG. 1 is a block diagram depicting an exemplary embodiment of the invented beverage brewing device.

FIG. 2 is a sectional elevation view depicting an exemplary embodiment of the invented beverage brewing device.

FIG. 3 is a perspective view depicting an exemplary embodiment of the invented beverage brewing device.

FIG. 4 is a flow diagram of a process for brewing a beverage using an exemplary beverage brewing device according to an embodiment of the invention.

### DETAILED DESCRIPTION

As used herein, the term ‘exemplary’ is intended to indicate an particular described embodiment, but neither precludes other embodiments nor is intended to indicate that the particular embodiment is preferred or particularly more advantageous than other embodiments. The applicant recognizes the impracticality of describing in detail every conceived embodiment of the invention, and that an ordinarily skilled artisan would recognize that the concise description provided herein likewise inherently or impliedly discloses a broader range of embodiments based on a multitude of alternative materials, components, arrangements, or combinations thereof.

The accompanying drawings are not drawn to scale, but rather are depicted so as to enhance clarity and understanding of the arrangement of the depicted features. Likewise, an ordinarily skilled artisan will recognize that the particular depicted arrangements of features can be variable from one embodiment to another without departing from the spirit and scope of the disclosed invention, because the shapes and sizes of brewing devices can be altered for aesthetics, to increase brewing capacity, to fit into differently sized architectural spaces (e.g., a cubby in a kitchen), or for other reasons.

Throughout this description, water is described as an exemplary liquid heated in the described embodiment and used to brew a beverage. However, the embodiments are not intended to be limited to water, and other liquids are likewise contemplated for heating and brewing a beverage.

FIGS. 1-3 depict an exemplary but non-exclusive embodiment of a novel beverage brewing device 100. FIG. 1 depicts features of the brewing device according to a block diagram, while FIGS. 2-3 depict the interior and exterior, respectively, of the brewing device and an exemplary housing.

In general, an exemplary embodiment of the device includes a pump 4 that receives a liquid, typically water, from a source 2. As depicted, the source is an incoming water line that may connect at the exterior of the housing 38, or may transit through the housing for connection within the housing interior. The pressure of the incoming water can be reduced prior to arrival at the pump 4 by placing a pressure-reducing valve 13 or similarly performing device in an incoming water flow path. The pump delivers the water through a “first” conduit 6 at a controlled rate into exposure to a heater 8, and subsequently to a dispensing outlet 10. The heater consistently heats the water to a target temperature that is designated by a user at a control interface 16. A thermal sensor (or ‘thermal sensing device’) 22 senses the temperature of the water exiting the heater, and logic circuitry 20 of a controller 18 determines whether the detected temperature differs from the user-designated temperature. If a difference is detected, the controller sends a signal to the pump to either accelerate or decelerate the pump operating rate and the flow rate of the water through the heater, until the water temperature attains the designated temperature. The user can view one or both of the designated water temperature and the current water temperature at a display 28.

Heated water arriving at the dispensing outlet 10 is then dispensed into contact with a particular flavoring medium 30 held within a perforated receptacle 12, typically comprising either or both of a basket and a filter. As used herein, the term ‘particulate flavoring medium’ is intended to also include and encompass flavoring media that are granulated, flaked, powdered, crushed, chopped, ground, or otherwise rendered as plural individualized particles each having a maximum outer dimension generally found within the range often microns to ten millimeters. The heater water flows through the flavoring medium, exits the perforated receptacle, and is collected in a reservoir 14. The heated water acquires flavoring compounds from the flavoring medium (e.g., ground coffee beans, tea leaves, cinnamon bark, chicory root, etc.), so that the water entering the reservoir 14 constitutes a brewed beverage (e.g., coffee, tea, etc.).

As shown in the exemplary embodiment, a bypass (“second”) conduit 24 diverts a portion of the heated water past the flavoring medium 30, and into the reservoir 14. The bypass conduit includes a user-adjustable flow control device 26 enabling a user to adjust a flow rate of water transiting the bypass conduit, and therefore to control a quantity of heated water that is delivered to the reservoir via the bypass conduit. Typically, the flow rate of water through the bypass conduit defines an approximate proportion of water bypassing the flavoring medium relative to an amount of water passing through the flavoring medium, enabling a user to closely control a concentration of flavoring compounds in a brewed beverage at a designated water temperature.

An ordinarily skilled artisan will recognize, therefore, that the embodiment depicted in FIGS. 1-3 provides unprecedented user control of the brewing process, and the flavor of a resulting brewed beverage, through at least the following:
a) enabling the user to establish a target water temperature for brewing;
b) maintaining the user-established water temperature via an integrated feedback-control circuit,
c) dispensing water at a consistent target temperature into contact with a flavoring medium; and
d) enabling the user to closely control an amount of heated water bypassing the flavoring medium and dispensing into a brewed beverage.

As will become apparent in view of the discussion that follows, some of the features depicted according to the embodiment in FIG. 1 are present in all or most of the contemplated embodiments, while other features may be present in only one embodiment or a small number of embodiments.

The brewing apparatus 100 is typically served by one or more operating power sources 1, such as an electrical power cord coupled with a household electrical outlet, or a pneumatic conduit coupled with a source of a pressurized gas, etc. Operating power sources provide an operating force—e.g. an electrical current, pressurized air, etc.—used to operate correspondingly configured components of the brewing apparatus. For example, electricity flowing through one or more electrical circuits within the brewing apparatus may operate an electric pump, an electric heater, logic circuitry of a microprocessor device, an LED display, and an electrically actuated valve, etc. Likewise pressurized air can be used to operate a pneumatic valve, a pneumatic pump, etc. An ordinarily skilled artisan will recognize that at least one embodiment can utilize more than one type of operating power source without departing from the scope of this description.

A water source 2, from which water or another liquid arrives at the pump 4, can be either a reservoir provided as a part of the brewing device (whether positioned within or outside the housing), or can be a supply conduit from an extrinsic source—e.g., a public water delivery system, a residential water tank, a connectable container, or another available source. The water source typically delivers water under pressure, whether developed due to gravity as with water draining from an elevated reservoir, or water delivered normally under pressure from a public or localized water delivery system. To control the pressure of water or another liquid at an inlet 3 to the pump 4, an incoming flow path can be provided with one or more pressure reducing devices, such as a pressure reducing valve 13.

Various forms of pressure reducing valves and other devices, whether individually or sequentially, are suitable for reducing an incoming water pressure into a suitable range between. For example, a suitable range can be found between zero and approximately ten pounds per square inch (0-10 p.s.i.), or more particularly, between zero and approximately five pounds per square inch (0-5 p.s.i.), or any range constituting a subset of those ranges, to provide a specified inlet water pressure to the pump. A contemplated embodiment includes a sequence of pressure reducing devices, or structures within a single such device, capable of receiving water at a pressure range normally expected in a residence, or an institutional or commercial setting (e.g., a restaurant kitchen)—up to approximately 120 p.s.i., for example—and reducing it to a pressure range suitable for introduction into a pump in the described and otherwise contemplated embodiments.

Alternatively, the water can arrive at the pump under a negative pressure, as when an inlet to the pump is positioned higher than an outlet from a reservoir, and the action of the operating pump draws liquid from the reservoir. Generally, a liquid arriving from the liquid source will be suitable for human consumption (potable) either as received, or after heating by the brewing device, although the incoming water can be filtered by a porous membrane, medium, an absorbent medium, or another drinking quality-enhancing material or structure, as is contemplated in an exemplary embodiment.

The pump 4 includes an inlet 3 for receiving water from the water source and admitting the water into the pump. The pump further includes an outlet 5 from which water exits the pump, typically under force produced by operation of the pump. Any of a wide number of pump types can be utilized without departing from the scope of the contemplated embodiments, including e.g., pneumatically, electrically, and mechanically actuated pumps, provided that the pump is or can be configured for receiving a control signal from an automated controller and altering an operating condition in response to the control signal. In an exemplary embodiment, the pump is electrically actuated, and includes electrically-conductive connections enabling the pump to receive an electrical control signal transmitted from the logic circuitry of an electrical controller.

An example of a suitable pump, according to an exemplary embodiment, includes the Model E, Type EP8 vibratory pump available from the ULKA Coffee Division of CEME Group (Carugate, Italy). Exemplary performance parameters for the EP8 pump include a flow rate of up to approximately thirteen hundred cubic centimeters per minute (˜1300 cc/min., or ˜0.286 gallons/min.), and a fluid pressure of up to approximately three and one-quarter bar (˜3.25 bar, or ˜47 pounds/in².). Pumps providing higher or lower output flow rates or pressures are likewise suitable in various contemplated embodiments, when matched with a heater that can accommodate the pump's operating parameters while heating water to a suitable temperature for brewing a beverage.

In an exemplary but non-limiting embodiment of the invented beverage brewing device, the heater 8 sequentially includes an inlet 7 by which a fluid can enter the heater, a heat source (not shown) configured to heat a fluid transiting the heater during operation, and an outlet 9 by which a fluid can exit the heater. The fluid path through the heater is typically configured to retain a liquid transiting the heater and to prevent the liquid from leaking. One or more portions of the heater typically surround the fluid path in an exemplary embodiment, although in at least another embodiment, conduit 6 simply extends across and in thermally conductive contact with the heater. Conceptually, the heater lies along the fluid flow path of the first conduit 6, without regard for whether the first conduit itself extends continuously across or through the heater, or instead the conduit 6 terminates at a leak-preventing connection with the heater inlet, and continues again from a leak-preventing connection with the heater outlet, wherein a leak-preventing channel extends through the heater, and wherein the channel takes the place of, and extends the fluid flow path of, the conduit 6 between the heater inlet and outlet.

A heat source of the heater can include any one or more of an electrical (resistance) heating element, an open flame (e.g., burning natural gas), an inductive heating element, and infrared heating element, a thick film heater, or another suitable heat source. A heat source is generally considered ‘suitable’ within the scope of this description and the accompanying claims when the heat source is capable of heating the water to a suitable beverage brewing temperature (discussed further infra) as the water passes through, across or is otherwise exposed to the heat source at a flow rate lying within the operating range of the pump.

A ‘suitable’ brewing temperature is any temperature lying within a range that is capable of extracting flavoring compounds from a flavoring medium. Exemplary temperature ranges for brewing beverages include the following: Coffee—195-205° F.; Tea—185-210° F.; powdered flavoring media—120-175° F. These temperature ranges represent examples only, and are not intended to limit the alternative ranges of suitable brewing temperatures for the indicated beverages or flavoring media, nor the temperature ranges for other beverages and flavoring media. Generally speaking, alternative embodiments of the contemplated device can elevate the temperature of an incoming liquid to any temperature that is higher than that of the liquid arriving from the liquid source, and is capable of extracting flavoring compounds from a flavoring medium.

An ordinarily skilled artisan will recognize, therefore, that the contemplated embodiments encompass a wide variety of heaters, the configurations and performance ranges of which enable them to meet the stated operational objectives. An exemplary heater suitable in one or more of the embodiments is the MK1.5 flow through heater from Ferro Techniek BV (The Netherlands), which can operate at an output flow rate of up to approximately ten milliliters per second (˜10 mL/sec.).

The heater 8 is typically coupled in electrical communication with logic circuitry 20 of a controller 18, and is configured to alter an operating condition of the heater in response to a control signal received from the controller. For example, altering an operation condition can include changing from an idle, non-heating operation condition to an active, heating operating condition (or vice versa), changing from a first heating level to a second higher or lower heating level (e.g., to either increase or decrease the level of heat output), changing from an active heating mode to a maintenance heating mode to maintain a fluid temperature at a then-present level (or vice versa), or other variations as would be recognized by an ordinarily skilled artisan in view of this entire description.

In at least one contemplated alternate embodiment, the controller includes a user-operated rheostatic control (e.g., an adjustable resistor) to vary an operating condition of the heater, and does not otherwise require or include special logic circuitry for that purpose.

The fluid conduit 6 (also referred to as the ‘first fluid conduit’ in this description and in the accompanying claims), forms a fluid path extending from the pump 4 toward a dispensing outlet 10, with the heater 8 being disposed within the fluid flow path of the first fluid conduit between the pump and the dispensing outlet.

In a typical embodiment, a portion of the first fluid conduit extends from the fluid outlet of the pump to the fluid inlet of the heater. The length of the fluid conduit portion between the pump and the heater is variable, enabling a high degree of flexibility for placing the pump and heater relative to each other in one embodiment of the invented brewing device relative to another. In at least one embodiment, the fluid outlet of the pump couples directly to the fluid inlet of the heater, in which case the fluid conduit portion between the pump and the heater comprises only the conjoined outlet and inlet structures, and not an additional tube, pipe, etc.

A second portion of the first fluid conduit typically extends from the fluid outlet of the heater 8 to the dispensing outlet 10. As described above regarding the first portion of the first fluid conduit, the length of the fluid conduit portion between the heater and the dispensing outlet is variable, enabling a high degree of flexibility for placing the heater relative to the dispensing outlet. In at least one embodiment, the fluid outlet of the heater couples directly to the dispensing outlet, in which case the fluid conduit portion between the heater and the dispensing outlet comprises only the conjoined heater outlet and dispensing outlet structures, and not an additional tube, pipe, etc.

The fluid conduit typically forms an enclosed fluid path, open only at a first end to receive a liquid from a liquid source 2, and at a second end to deliver the liquid to the dispensing outlet 10. In at least one embodiment, however, a second fluid conduit additionally bifurcates from the otherwise unidirectional flow path of the first conduit, wherein the second conduit is coupled with and configured to receive from the first conduit a diverted portion of a flowing liquid. The coupling between the first and second conduits is generally also configured to prevent leaks while not substantially obstructing liquid flow through the first conduit or into the second conduit. The coupling can be configured to enable the second conduit to diverge from the first conduit at nearly any angle, but the junction between the first and second conduits will typically be configured to form an angle found within the range of five to ninety degrees. More preferably, the junction angle is configured to be found within the range of forty-five to ninety degrees, enabling the use of commonly configured fluid conduit connecting devices (e.g., a ninety degree ‘T’ connector, a forty-five degree ‘Y’ connector, etc.).

A suitable material for each of the first and second conduits generally maintains its form and structural integrity even when exposed for extended periods of time to a liquid, most typically water, heated to a temperature found within the range discussed infra for brewing a beverage. Additionally, a suitable material for each of the first and second conduits does not leach out compounds that affect the flavor, color, or odor of the liquid, or otherwise affect the liquid's suitability for human consumption when exposed to the heated liquid. Exemplary conduit material include various types of food grade silicone, nylon, polyvinyl chloride (PVC), copper, stainless steel, glass, and others as would be inherently or impliedly recognized as suitable by an ordinarily skilled artisan in view of this entire description.

While the pump, the heater, and the first conduit are typically retained within an outer housing 38 of a beverage brewing apparatus, the dispensing outlet 10 is typically presented, at least in part, at an exterior of the housing for dispensing the heated liquid into contact with a flavoring medium 30 held within a receptacle 12. As an ordinarily skilled artisan will readily recognize, presenting a large surface area of flavoring medium to the heated fluid advantageously encouragaes full, even and consistent wetting of the flavoring medium, for efficient extraction of flavoring compounds during the brewing process. Both the dispensing outlet and the flavoring medium receptacle are configured with this principle in mind.

Advantageously, the dispensing outlet 10 is configured similar to a shower head, with a liquid arriving via a narrow fluid inlet, encountering a dispersing structure (e.g., a dispersal plate) configured to at least partially obstruct continued flow in the direction of arrival, and to redirect a portion of the liquid into multiple directions and to broaden the flow path. Frequently, the dispensing outlet includes an internal chamber that is wider than the entry port to the dispensing outlet, wherein a liquid can accumulate before being dispensed into the receptacle. The dispersing structure frequently includes multiple, small orifices distributed in a relatively regular pattern across its surface, from which the liquid emerges at a controlled rate. Additionally, the pattern of orifices is typically, although not exclusively, configured to correspond closely in breadth to that of the upwardly presented surface of the flavoring medium. Therefore, during operation, the entire surface of the flavoring medium is wetted by the liquid emerging from the dispensing outlet.

Typically, the size of each orifice is configured to allow passage of a liquid at a rate that is controlled largely by the pressure of the fluid arriving from the first conduit, which in turn corresponds to an output pressure developed by the pump. The liquid emerging from each orifice typically drips or trickles onto the flavoring medium at a slow rate, rather than emerging as a pressurized stream. In particular, apart from perhaps dimpling the surface of the flavoring medium to a small extent, the force of the liquid emerging from the dispensing outlet and striking the surface of the flavoring medium is generally not great enough to excavate a significant depth into a flavoring medium.

The interior of the receptacle 12 typically includes a perforated bottom coupled with non-perforate sides, although lower portions of the sides may also be perforated in embodiments. The interior of the receptacle is an inverted frusto-conical shape in an embodiment, with the sides narrowing from a wider upper portion to a smaller bottom portion as shown in FIG. 2, to funnel a liquid downwardly through a flavoring medium contained within the receptacle. In another embodiments, the sides of the receptacle are generally cylindrical, although alternative configurations are contemplated and not precluded by these exemplary embodiments. For example, the receptacle may be configured as or within a drawer, or to swing outwardly from the brewing apparatus, such as for adding or removing a flavoring medium, or for cleaning. In a typical but non-exclusive embodiment, the receptacle is wider than it is tall.

In preferred embodiments, the heater is disposed closely to the dispensing outlet, minimizing a length of the first conduit between the heater and the dispensing outlet. Such placement minimizes cooling of the heated water prior to dispensing, which in turn saves energy and helps promote consistency between a user-designated temperature and an actual temperature of the water used to brew the beverage. Additionally, a thermally insulating material surrounding at least a portion of the first conduit is provided in embodiments to help maintain the heated liquid at a consistent temperature prior to dispensing.

The thermal sensor 22 is typically coupled with either or both of the heater and the first conduit, to detect a thermal condition of a liquid within the first fluid conduit downstream from the heater. Preferably, the thermal sensor is positioned to detect a temperature of the liquid closely following exposure to the heat source of the heater. Some suitable heaters include an integrated thermal sensor, obviating a need to provide a thermal sensor as a separate component. Such close proximity promotes fidelity between a detected water temperature and an actual maximum water temperature emerging from the heater, which in turn facilitates precise user control of the brewing conditions.

The thermal sensor may be placed in direct contact with the heated liquid, as through a sensor port provided in the first conduit for that purpose, or it may lie entirely outside the first conduit yet be configured to accurately detect and report a temperature of liquid transiting through the first conduit. For example, in embodiments where a portion of the first conduit is formed of a highly thermally conductive material, the sensor can be a laser based thermal sensor, or an infrared sensor, configured to measure a temperature of the outside of the first conduit as a proxy for the temperature of the heated liquid transiting through the first conduit.

Preferably, a suitable thermal sensor will be configured to measure accurately across a wide range of temperatures to which a suitable heater can heat water during operation. Additionally, a suitable thermal sensor, according to an exemplary embodiment, measures temperatures with a resolution to tenths of a degree Celsius, or at least with a resolution to one degree Celsius, and can produce a corresponding indication of such temperature measurement; e.g., a visually-displayed indication, or an electrical signal corresponding to a measured temperature, etc.

Additionally, the thermal sensor is operably coupled with a display device 28, typically but not exclusively via the logic circuitry 20, and the display device is configured to produce a user-detectable indication of the thermal condition of the liquid. For example, the thermal sensor may produce an electrical signal corresponding to a temperature of two hundred degrees Fahrenheit (200° F.). The signal is conveyed via a conductive pathway (e.g., a wire, a printed circuit pathway, an optical fiber, etc.) to the display, which then indicates to the user a recognizable indication of the detected temperature of two hundred degrees. The indication can be analog, such as via a dial thermometer; graphical, such as via a graphical user interface; numerical, such as via a light-emitting diode (LED) display or a liquid crystal display (LCD); audible, such as via a voice emulator channeled through a speaker device, or via any other similar device or technology currently known in the art. As used herein, the term ‘user-detectable indication’ is intended to broadly include or encompass an indication, produced by any device, assembly, or technology, that is capable of informing a user (e.g., of the detected temperature of a heated liquid) in a manner which can be discerned or detected by the user.

In embodiments, the display device 28 is operably configured to receive and to viewably display any of the one or more operational parameters that are either measured by a sensor, adjustable by the user, or pre-programmed into the memory 36 of the brewing device by the manufacturer. Likewise, the user interface enables the user to scroll through and view values of various parameters displayed at the display device, and to view changes to the values of user-adjustable parameters in real-time as the user affects such changes via the user control interface.

Embodiments of the invented brewing device also typically include a user control interface 16 at which a user can designate one or more settings (e.g., operational parameters, brewed beverage characteristics, etc.) affecting the performance of the brewing apparatus (e.g., water temperature, pump rate, bypass fluid flow rate, etc.). An embodiment contemplates including separate user control interfaces for each of plural operational parameters, while another embodiment contemplates combining controls for two or more operational control parameters into a single user control interface. The user may likewise view and select from among plural predetermined (either saved in memory during manufacturing of the brewing device, or saved into memory by the user during a previous operation, etc.) brewing ‘recipes,’ or sets of functional parameters for one or more of the described components.

The variety of contemplated user-operable control interface structural and operational configurations is broad. A user can directly enter a numerical value corresponding to an operational parameter, or can increment or decrement an already selected or factory-designated ‘default’ value. Alternatively, the user can simply turn a dial, or slide a lever, or otherwise adjust a manually adjustable control mechanism to alter a setting (selection) for an operational parameter. For example, an exemplary but non-limiting list of user-operable selection mechanisms 17 of a control interface, for selecting or adjusting a particular operational parameter, include at least the following: manually-operated rotary dials; sliding levers; touch-screen panels; pressure-sensitive buttons (as shown at 17 in FIG. 3); keyboards and keypads; joysticks; and any others configured to enable a user to designate or adjust a setting for an operational parameter. In a typical embodiment, the brewing apparatus will also include a user-operable control 19 (“On/Off” switch) for turning on and off the power to the brewing apparatus. The on/off switch 19 may also be provided at a portion of the user-operable control interface, or may be provided elsewhere along the exterior of the housing 38.

The selection mechanisms of a control interface may further be coupled with a visual monitor, or other visual or audible indicator, configured to inform a user regarding the parameter setting corresponding to the user's selection, so that a user can visually observe/confirm that the selected setting matches an intended setting. Examples of such indicators can include markings surrounding a rotary dial (similar to the indicator markings 29 adjacent to the dial 27 shown in FIG. 3, for example) or aligned along a sliding lever, numbers on an LCD or LED display, a series of displayed bars or lights that appear or illuminate in sequence corresponding to an incrementing or decrementing value for a parameter, or any of a wide range of other machine parameter setting indicators that would be recognized by an ordinarily skilled artisan.

Particularly beneficial in embodiments, is the fact that the user-operable selection mechanisms enable the user to make minute adjustments across a range of settings, rather than simply providing two or three options pre-determined and pre-set by the manufacturer of the brewing device. Such highly-variable, user-selectable settings enables significant user-control over numerous characteristics of a brewed beverage, such as flavor, color, temperature, bitterness, acidity, and others.

In an exemplary embodiment, the user interface includes a selection mechanism (e.g., a ‘Menu’ button, etc.) that enables a user to select from among two or more predetermined sets of parameters, each corresponding to a particular brewing ‘recipe.’ For example, brewing recipes can each correspond to one of several types or roasts of coffee, or can correspond to different types of beverages (e.g., coffee, tea, etc.). A brewing recipe can also correspond to an environmental condition, such as a particular altitude at which brewing may occur. After selecting from among such predetermined brewing recipes, the user can then use the interface to vary one or more of the brewing parameters to arrive at a recipe that more closely suits the user's preference. Further, the control interface likewise includes, in an embodiment, a selection enabling the user to save into the memory 36 a particular brewing recipe, such as a customized recipe prepared by the user, which the user can then recall from the memory and select for use again in the future.

Further, the user control interface is coupled in operable communication with one or more controllers 18 in a contemplated embodiment. In a typical embodiment, the user-operable control interface is configured, in response to an action of the user upon the interface, to affect a control condition of the controller. For example, a user selects a water temperature setting, which in turn causes the controller to alter a cycle rate of a pump control signal, or to otherwise produce a tangible output configured to affect an operating condition of the pump.

A controller can be a purely mechanical device—such as a pneumatic valve controlled by a user-operable manual dial—or can be an electronic device equipped with or coupled to operable logic circuitry 20 (e.g., one or more solid-state processors) configured to respond and exercise control of an operably coupled component of the brewing device according to a user's actions relative to an electronic user control interface.

Additionally, an electronic controller typically includes or is operably coupled with one or more non-transitory memory devices 36, such as a solid state memory device with ROM, RAM, EEPROM, or another memory format, a magnetic memory media and reader, an optical memory media and reader, etc., configured to store user-designated parameter settings, pre-set default settings, or ‘learned’ settings corresponding to a particular measured result. The controller, when provided as an integrated electronic device or assembly, can further execute coded instructions configured as software or firmware stored at a non-transitory memory medium or device 36. An electronic controller assembly may typically also include a printed circuit board (‘PCB’) with which the logic circuitry and other electronic components (e.g., resistors, capacitors, inductors, wiring connectors, etc.) are operably coupled and interconnected via conductive pathways integrally formed with and at a surface of the PCB.

An exemplary controller in an embodiment includes a low pin-count flash microcontroller integrated circuit device available from the Microchip Technology Inc. (Chandler, Ariz.), and identified by the designation PIC16F685.

In an exemplary embodiment, the pump, the thermal sensing device, and the user-operable control interface, are each coupled in operable communication with the logic circuitry of the controller, collectively forming a feedback-response circuit during operation. Connections 65 providing such communication are shown in FIGS. 1-2 as arrowed lines, for example, and may be configured as any material or structure capable of conveying an electrical, optical, or pneumatic impulse or signal (e.g., insulated copper wire, optical fiber, or nylon tubing, respectively), according to alternative embodiments. An ordinarily skilled artisan will recognize that similarly depicted lines in FIGS. 1-2, although unlabeled, likewise represent communication pathways for carrying signal between components of the brewing device.

The contemplated embodiments also include at least one in which one or more controllers 18 are integrated with the user control interface 18, or the display is integrated with the user control interface, or a controller is integrated with a component (e.g., the pump 4, the heater 8, the adjustable flow control 26, etc.), and the communication pathways 65 will accordingly vary from the arrangement depicted in FIGS. 1-2.

The logic circuitry is configured, for example, to receive from the control interface a first signal indicating a temperature setting selected by the user, and to store the selected temperature setting in the memory. The logic circuitry is also configured to receive from the thermal sensing device a signal indicating a detected thermal condition of a liquid. The logic circuitry is further configured to compare the first signal and the second signal, and to detect a difference between the user-selected temperature and the thermal condition of the liquid. In response to detecting such difference, the logic circuitry is further configured to cause the controller to transmit an operation condition-affecting control signal to the pump, to cause the pump to either increase or decrease a pumping rate, for example.

As an ordinarily skilled artisan will readily recognize in light of this description, affecting a pumping rate of the pump correspondingly affects a flow rate of a liquid through the heater disposed downstream from the pump. When the logic circuitry determines that the detected water temperature of water exiting the heater is lower than the user-designated temperature, the controller causes the pump to decrease its pump rate, which correspondingly causes water to flow more slowly through the heater. The water, therefore, remains exposed to the heat source for a longer period of time, enabling the heater to heat the water more thoroughly. When the water temperature exiting the heater reaches the user-designated temperature as measured by the thermal sensor and determined by the logic circuitry, the controller can be configured to either maintain the pump rate at the adjusted, slower pump rate, to resume the prior ‘pre-adjustment’ pump rate, or to adjust to some predetermined (e.g., default) pump rate.

Conversely, when the water temperature is determined to exceed the user-designated temperature, a signal from the controller causes the pump to increase its pump rate, correspondingly increasing a flow rate of water through the heater. The water is exposed to the heat source for a shorter period of time, resulting in a less heating of the water and a lower temperature of the water exiting the heater.

The water temperature measurement and feedback loop described above generally takes place continuously and automatically during operation of the brewing apparatus, as controlled by the user's temperature selection at the control interface. Further, the described apparatus is typically capable of maintaining the water temperature within a very narrow temperature range relative to the user's selected temperature, enabling close control of the brewing process and consistent results in the brewed beverage output from the process.

Water temperature is not, however, the only determinant of the characteristics of a brewed beverage, such as flavor, color, bitterness, caffeine content, etc. Therefore, embodiments of the invention further include a user-controllable bypass arrangement configured to divert a portion of the heated water into a brewed beverage without first contacting a flavoring medium. The bypass arrangement described herein dilutes the brewed beverage by an amount selected by the user, while maintaining the consistent temperature selected by the user.

As shown in FIGS. 1-2, an exemplary embodiment includes a second fluid conduit 24 coupled in fluid communication with the first conduit 6 and configured to receive a portion of the heated liquid transiting through the first conduit. The second conduit diverts the received liquid portion so that liquid does not flow through the flavoring medium 30. Instead, the diverted liquid is routed to a bypass outlet 32 which dispenses the diverted liquid into the brewed beverage reservoir 14 (e.g., a coffee pot, tea pot, etc.). As with the first conduit, a thermally insulating material can be provided about the second conduit to help maintain a consistent temperature of the heated liquid transiting through the second conduit.

The bypass outlet and the dispensing outlet are separate structures in a typical but non-exclusive embodiment. Alternatively, the bypass outlet and dispensing outlet can be combined within a single structural feature (e.g. separate portions of the retainer 12), while separately dispensing heated liquid from each into a brewed beverage receptacle, with only the liquid from the dispensing outlet being dispensed into contact with flavoring medium.

To enable the user to control the amount of heated liquid bypassing the flavoring medium, the exemplary embodiment of FIG. 1 includes a user-operable fluid flow control device 26 coupled in fluid communication with the second conduit 24 and configured, when operated by a user, to affect a flow rate of a liquid transiting the second conduit. A suitable flow control device 26 in the contemplated embodiments can be, for example, a manually-actuated valve (e.g., a stopcock, etc.), an electrically-actuated valve (e.g., a solenoid valve, etc.), a pneumatically actuated valve, or a valve actuated by any other method or mechanism that would be known to an ordinarily skilled artisan. The flow control device may be rendered user-operable by being coupled with a user-adjustable selection mechanism 27, which can be physically and operationally configured similarly to the user-operable selection mechanisms 17 described above. For example, the user-adjustable bypass flow rate selection mechanism can be a rotary dial surrounded by indicator markings 29, as shown in the exemplary embodiment of FIG. 3.

In embodiments utilizing an electrically-actuated valve, the adjustable flow control device is typically coupled with a user-operable bypass flow control interface, which may be a distinct portion of the control interface that enables the user to designate a brewing fluid temperature, or may be a separately provided user-control interface. The user-operable bypass control interface includes, for example, user-operable selection mechanisms configured to enable a user to designate or otherwise affect a bypass flow rate setting, as described supra regarding temperature settings.

Further, either or both of the fluid flow control device 26 and the user-operable bypass control interface are coupled with the controller 18 and associated logic circuitry 20 in an embodiment. In such arrangement, user selections entered at the bypass control interface are communicated to the controller, processed by the logic circuitry, and a control signal is sent to the bypass flow control device to affect a change in the flow rate of a heated fluid transiting the second conduit.

In embodiments, flow rate sensors may be included in either or both of the first conduit and the second conduit, to measure a flow rate of a liquid transiting each respective conduit. For example, a flow rate sensor 37 disposed downstream from the bypass flow control device and configured to measure a liquid flow rate, could be operably coupled with a flow rate display device (e.g., dial gauge, digital display, etc.) to indicate to a user a quantified value of a then-present liquid bypass flow rate. Such information advantageously enables the user to select a specified value corresponding to a user-preferred bypass flow rate.

Alternatively, the bypass flow rate sensor could be coupled with the logic circuitry associated with the controller as part of a feedback circuit. When the logic circuitry detects that a then-present bypass flow rate does not match a bypass flow rate value selected by the user, the controller then sends a control signal to the bypass flow control device, and the flow control device responsively adjusts to either decrease or increase the bypass flow until the flow rate detected by the bypass flow rate sensor matches a user selected flow rate value. An exemplary but not exclusive logic flow for such process in an embodiment is as follows:

1. Brewing cycle initiated.

2. Count PumpControl1 until CycleCount1=Initial+5.

3. Read FlowRateSetting1 value from FlowRateSetting1 register in memory.

4. Read FlowRateSensor1 value from FlowRateSensor1.

5. If FlowRateSensor1 value equals FlowRateSetting1 value, go to step 6; else:
4a. For FlowRateSensor1 value greater than FlowRateSetting1 value, increment ByPassValve1Control value by 1.
4b. For FlowRateSensor1 value less than FlowRateSetting1 value, decrement ByPassValve1Control value by 1.

6. Return to step 2.

In the above indicated exemplary logic flow, ‘PumpControl1’ represents an operational control function parameter (e.g. pump actuation signals) for a pump 4, and ‘CycleCount1’ represents an value corresponding to a cumulative number of pump control cycles. ‘Initial’ represents a value for CycleCount1 when a particular iteration of step 2 initiates, therefore, the value of ‘Initial’ may be different each time step 2 is performed. According to the logic flow, step 2 continues until the value for ‘CycleCount1’ increments to a value that is five pump cycles higher than the ‘Initial’ value. The ‘FlowRateSetting1’ value represents a predetermined or user designated setting for a bypass flow rate, which is saved in a portion of memory correspondingly designated ‘FlowRateSetting1.’ The ‘FlowRateSensor1’ value represents a flow rate measured by the bypass flow rate sensor 37, which is in turn designated ‘FlowRateSensor1.’ The ‘ByPassValve1Control’ value represents an operational control parameter of a controller for the bypass flow control device 26. Incrementing or decrementing the ‘ByPassValve1Control’ value causes a controller 18 to affect a change in the bypass flow control device, correspondingly enabling an increase or decrease in the flow rate through the bypass conduit 24.

In a typical embodiment, the invented beverage brewing apparatus includes an outer housing within which the various described features and parts are either entirely or partially retained. For example, in addition to the pump, heater, and the first conduit, one or more of the second conduit, a bypass flow control device, a thermal sensor, a controller (including associated logic circuitry and memory), and a fluid source (e.g., a reservoir) may generally be contained within the housing. However, devices that the user interacts with, such as the user-operable control interface(s) and selection mechanism(s), and display device(s), are typically coupled with the housing with their user-operable and user-viewable portions presented outwardly for access by the user. Additionally, the flavoring medium receptacle and brewed beverage reservoir are typically accessed by the user before, during, or following the beverage brewing operation, and therefore those features are likewise presented outwardly from the housing or otherwise accessible to the user. The particular aesthetic design of the housing is not limited to the exemplary embodiments depicted in FIGS. 2 and 3, except to the extent that the housing will typically accommodate and facilitate the function of the described features in the several embodiments.

In one embodiment, controllers for two or more of a heater, a pump, an adjustable flow control device, a display, a clock, and other controllable components of the brewing device are consolidated either within an single integrated circuit microcontroller device, or as multiple such devices operably coupled with a single PCB. Alternatively, one or more controllers for such components can be provided as ‘stand-alone’controller devices, whether embodied as a mechanical controller (e.g., a flow control valve, etc.) or an integrated circuit microcontroller device. The contemplated embodiments include any and all arrangements of controllers, accommodating variations in component layout for simplicity of assembly, operation, troubleshooting, maintenance, repair, upgrading, and other considerations or benefits.

In addition to the structure and function of the described brewing device embodiments, the invention includes a method of brewing a heated beverage according to such embodiments. An embodiment of such method 400 is shown in FIG. 4, and includes the operations of:
a. selecting a fluid temperature setting 42 via a user-operable control interface;
b. reducing a pressure 43 of a fluid arriving from a fluid source, via a pressure reducing device;
c. pumping a fluid 44 via a pump;
d. heating the pumped fluid 46 via a heater;
e. determining a temperature of the heated fluid 48 via a thermal sensor;
f. comparing the detected fluid temperature to the fluid temperature setting 50 via logic circuitry;
g. affecting an operating condition of the pump 50, via the logic circuitry, in response to detecting a difference between the selected fluid temperature setting and the detected temperature of the heated fluid; and
h. dispensing the heated fluid 56 into a flavoring medium receptacle via a dispensing outlet.

In embodiments or installation situations where an expected water pressure incoming from a water source does not exceed a specified maximum incoming water pressure for the pump, the operation of reducing the pressure of the incoming water can be omitted. Likewise, when a temperature of water exiting the heater is determined to match, within an acceptable range, the fluid temperature setting, then the operation of affecting an operating condition of the pump will typically be omitted in an iteration of the operation, although such operation will typically occur at some point during the operation of an embodiment of the invented device, such as at the beginning of and periodically throughout a brewing cycle.

Typically, affecting the operating condition of the pump comprises either increasing the flow rate of the fluid through the heater in response to determining that the temperature of the heated fluid is greater than the selected fluid temperature, or decreasing the flow rate of the fluid through the heater in response to determining that the selected fluid temperature is lower than the temperature of the heated fluid. An exemplary but not exclusive logic flow for such process in an embodiment is as follows:

1. Brewing cycle initiated.

2. Count PumpControl1 until CycleCount1=Initial+5.

3. Read TempSetting1 value from TempSetting1 register in memory.

4. Read Temp1 value from TempSensor1.

5. If Temp1 value equals TempSetting1 value, go to step 6; else:
4a. For Temp1 value greater than TempSetting1 value, increment PumpControlRate1 value by 1.
4b. For Temp1 value less than TempSetting1 value, decrement PumpControlRate1 value by 1.

6. Return to step 2.

In light of the above discussion regarding the bypass logic flow, as well as the information disclosed in this entire description and the accompanying drawing figures, an ordinarily skilled artisan will readily recognize and understand the pump rate control and feedback operations represented by the above logic flow. For additional clarity, however, the ‘PumpControlRate1’ value represents a setting for a pump control parameter that controls a cycle rate for actuation signals sent to the pump; how many times the pump actuates within a specified time duration (e.g., 60 cycles/minute, etc.). Additionally, the ‘Temp1’ value represents a temperature of water exiting the heater, as measured by ‘TempSensor1,’ the thermal measuring device 22.

Additionally or alternatively, an embodiment of a method for brewing a beverage includes diverting a portion of the heated fluid into a bypass fluid conduit, at 54, upstream from the dispensing outlet, in which the bypass conduit is configured to bypass a flavoring medium retained in a receptacle, and to instead dispense the fluid into a reservoir 62 provided downstream from the receptacle to receive and retain the brewed beverage. When a user-operable flow control mechanism is operably coupled with the second conduit, the method can likewise include selecting a flow rate 58 via a user-adjustable selection mechanism operably coupled with a user-operable fluid flow control mechanism. Adjusting the user-adjustable flow rate selection mechanism correspondingly affects an operating condition of the flow control mechanism, which in turn affects a flow rate of the diverted portion of the heated fluid, at 60.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method and apparatus described and illustrated herein may be implemented in hardware, software and firmware, or any suitable combination thereof. Preferably, the method and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A beverage brewing apparatus, comprising:
a pump having a first fluid inlet for receiving a liquid from a liquid source, and further having a first fluid outlet;
a first fluid conduit having a first end coupled in fluid communication with the first fluid outlet, the first fluid conduit configured to form a fluid flow path extending from the pump toward a dispensing outlet;
a receptacle configured to retain a flavoring medium;
a dispensing outlet coupled in fluid communication with the first fluid conduit and disposed above the receptacle, the dispensing outlet being configured to receive a liquid from the first conduit and to dispense the liquid into a flavoring medium receptacle;
a heater disposed along the fluid flow path of the first fluid conduit;
a controller operably coupled with the pump and configured, when operated, to affect an operating condition of the pump; and
a user-operable control interface operably coupled with the controller.

2. The brewing apparatus of claim 1, further comprising a thermal sensing device operably coupled with either or both of the heater and the first conduit, the sensing device being disposed and configured to detect a thermal condition of a liquid within the first fluid conduit downstream from the heater.

3. The brewing apparatus of claim 3, wherein the thermal sensing device is operably coupled with a display device, and the display device is configured to produce a user-detectable indication of the thermal condition of the liquid.

4. The brewing apparatus of claim 3, wherein the user-operable control interface is configured, in response to an action of the user upon the interface, to affect a control condition of the controller.

5. The brewing apparatus of claim 1, wherein the user-operable control interface includes at least one user-operable selection mechanism configured to enable the user to designate a liquid temperature selection.

6. The brewing apparatus of claim 2, wherein the pump, the thermal sensing device, the user-operable control interface, and the controller are each coupled in electrical communication with logic circuitry of a feedback-response circuit.

7. The brewing apparatus of claim 6, wherein the logic circuitry is configured to:
receive from the control interface a first signal indicative of a temperature selection by the user at the user interface;
receive from the thermal sensing device a second signal indicative of a thermal condition of a liquid detected by the thermal sensing device;
compare the first signal and the second signal via a comparator;
detect a difference between the user-selected temperature and the detected thermal condition of the liquid; and
cause the controller to transmit an operation condition-affecting control signal to the pump.

8. The brewing apparatus of claim 1, wherein affecting an operating condition of the pump correspondingly affects a flow rate of a liquid transiting the heater.

9. The brewing apparatus of claim 4, wherein the user-operable interface is a touch screen device configured to produce an operable control signal in response to a detected user selection at a surface of the touch screen device.

10. The brewing apparatus of claim 1, further comprising a second conduit coupled in fluid communication with the first conduit, the second conduit being configured to receive a portion of a liquid from the first conduit and to divert the received liquid portion away from the flavoring medium.

11. The brewing apparatus of claim 10, further comprising a user-operable fluid flow control device coupled in fluid communication with the second conduit and configured, when operated, to affect a flow rate of a liquid transiting the second conduit.

12. The brewing apparatus of claim 11, wherein the user-operable flow control device includes a manually-actuated valve.

13. The brewing apparatus of claim 11, wherein the user-operable flow control device includes an electrically-actuated valve.

14. The brewing apparatus of claim 11, wherein the user-operable flow control device includes a pneumatically-actuated valve.

15. A beverage brewing apparatus, comprising:
a pump having a first fluid inlet for receiving a liquid from a liquid source, and further having a first fluid outlet;
a first fluid conduit having a first end coupled in fluid communication with the first fluid outlet; the first conduit being configured to convey a liquid away from the pump and toward a dispensing outlet;
a receptacle configured to retain a flavoring medium;
a dispensing outlet coupled in fluid communication with the first conduit and disposed above the receptacle, the dispensing outlet being configured to receive a liquid from the first conduit and to dispense the liquid into a flavoring medium receptacle;
a second conduit having a first end coupled in fluid communication with the first conduit, the second conduit being configured to receive a portion of a liquid from the first conduit and to divert the received liquid portion away from the flavoring medium receptacle; and
a user-operable fluid flow control device coupled with the second conduit and configured, when operated, to affect a flow rate of a liquid transiting the second conduit.

16. The beverage brewing apparatus of claim 15, further comprising a heater disposed within the fluid flow path of the first fluid conduit upstream from the second conduit.

17. The beverage brewing apparatus of claim 16, further comprising a controller operably coupled with the pump and configured, when operated, to affect an operating condition of the pump.

18. The beverage brewing apparatus of claim 17, further comprising a thermal sensing device operably coupled with either or both of the heater and the first conduit, the sensing device being disposed and configured to detect a thermal condition of a liquid within the first fluid conduit downstream from the heater.

19. The beverage brewing apparatus of claim 18, further comprising a user-operable control interface operably coupled with the controller.

20. The brewing apparatus of claim 18, wherein the thermal sensing device is operably coupled with a display device, and the display device is configured to produce a user-detectable indication of the thermal condition of the liquid.

21. The brewing apparatus of claim 19, wherein the pump, the thermal sensing device, the user-operable control interface, and the controller are each coupled in electrical communication with logic circuitry of a feedback-response circuit.

22. The brewing apparatus of claim 19, wherein the user-operable control interface is configured, in response to an action of the user upon the interface, to affect a control condition of the controller.

23. The brewing apparatus of claim 19, wherein the user-operable control interface is configured with at least one user-operable selection mechanism configured to enable the user to designate a liquid temperature selection.

24. The brewing apparatus of claim 17, wherein affecting an operating condition of the pump correspondingly affects a flow rate of a liquid through the heater.

25. The brewing apparatus of claim 19, wherein the user-operable interface is a touch screen device configured to produce an operable control signal in response to a detected user selection at a surface of the touch screen device.

26. The brewing apparatus of claim 15, wherein the user-operable flow control device includes a manually-actuated valve.

27. The brewing apparatus of claim 15, wherein the user-operable flow control device includes an electrically-actuated valve.

28. The brewing apparatus of claim 15, wherein the user-operable flow control device includes a pneumatically-actuated valve.

29. A method for brewing a heated beverage, comprising:
accepting a fluid temperature setting via a user-operable control interface;
pumping a fluid via a pump;
heating the pumped fluid via a heater;
determining a temperature of the heated fluid via a thermal sensor;
comparing the detected fluid temperature to the fluid temperature setting via logic circuitry;
affecting an operating condition of the pump, via the logic circuitry, in response to detecting a difference between the selected fluid temperature setting and the detected temperature of the heated fluid; and
dispensing the heated fluid into a flavoring medium receptacle via a dispensing outlet.

30. The method of claim 29, wherein the affecting the operating condition of the pump comprises increasing the flow rate of the fluid through the heater in response to determining that the temperature of the heated fluid is greater than the accepted fluid temperature setting.

31. The method of claim 29, wherein the affecting an operating condition of the pump comprises decreasing the flow rate of the fluid through the heater in response to determining that the temperature of the heated fluid is lower than the accepted fluid temperature setting.

32. The method of claim 29, further comprising diverting a portion of the heated fluid upstream from the dispensing outlet into a bypass fluid conduit configured to bypass the flavoring medium receptacle.

33. The method of claim 32, further comprising accepting a flow rate setting of the diverted portion of the heated fluid via a user-adjustable flow rate selection mechanism operably coupled with a user-operable fluid flow control mechanism.

34. The method of claim 33, further comprising affecting the flow rate of the diverted portion of the heated fluid, via the user-operable fluid flow control mechanism coupled with the bypass fluid conduit, according to the accepted flow rate setting.

35. The method of claim 32, further comprising dispensing the diverted portion of the heated fluid into a reservoir downstream from a flavoring medium.
